(19) United States
(12) Patent Application Publication
(10) Pub. No.: US 2006/0283663 A1
(43) Pub. Date: Dec. 21, 2006

(54) Ladder securement device for vehicle ladder racks

(76) Inventor: Mark B. Fenner, Cloverdale, CA (US)

Correspondence Address: LAW OFFICES OF ADAM H. JACOBS;SUITE 726, 1904 FARNAM STREET, OMAHA, NE, 68102, US

(21) Appl. No.: 11/154,351

(22) Filed: Jun. 16, 2005

(51) Int. Cl. E06C 5/00

(52) U.S. Cl. 182/127

(57) ABSTRACT

An improved ladder securement device for a ladder rack includes at least one pivot mount adapted for mounting on a ladder rack and a generally horizontal pivot bar pivotably mounted on the at least one pivot mount rotatable about an axis generally defined by a center longitudinal axis of the pivot bar. At least two generally inverted L-shaped ladder-engaging hooks are mounted on the pivot bar adjacent opposite ends thereof, the ladder-engaging hooks pivotable between a ladder engaging position and a ladder release position and a handle is connected to the pivot bar for rotating the pivot bar about the center longitudinal axis thereof. Finally, the ladder-engaging hooks are adapted to extend over and engage a side rail of at least one ladder mounted on the ladder rack when the ladder-engaging hooks are in the ladder engaging position.

### BACKGROUND OF THE INVENTION

1. Technical Field

The present invention relates to ladder securement devices for vehicles and, more particularly, to a ladder securement device for use with ladder racks which includes at least one pivot mount adapted to be mounted on a ladder rack and a generally horizontal pivot bar pivotably mounted on the pivot mount which is rotatable about an axis generally defined by the center longitudinal axis of the pivot bar, at least two generally inverted L-shaped ladder-engaging hooks mounted on the pivot bar adjacent opposite ends thereof, the ladder-engaging hooks pivotable between a ladder engaging position and a ladder release position, a handle operatively connected to the pivot bar for rotating the pivot bar about the center longitudinal axis thereof, and the ladder-engaging hooks adapted to extend over and engage a side rail of at least one ladder mounted on the ladder rack when the ladder-engaging hooks are in the ladder engaging position.

2. Description of the Prior Art

There are many different types of ladder racks which are used on trucks, cars, and the like, for carrying of ladders to and from various job sites. In general, a ladder rack includes a generally rectangular frame structure mounted above the bed of a pickup truck with ladders being secured to the upper part of the ladder rack so that they may extend forwards and rearwards from the bed of the pickup truck. In most cases, the ladder is secured to the ladder rack by straps, tie-downs or the like, although there are other devices which can be used for securement of a ladder on a ladder rack. For example, one may use a clamping device to secure the ladder on the ladder rack or any other type of appropriate securement device. A clear disadvantage of the use of such tie-downs, clamps and the like is that one must climb the side of the ladder rack to the elevated position where the ladder is mounted in order to properly secure the ladder on the ladder rack. Accessing the top of the ladder rack to secure the ladder can be a dangerous and risky proposition and therefore there is a need for a ladder securement device for use with ladder racks which will not require the user to access the top of the ladder rack structure to secure the ladder thereon.

There are several different types of ladder securement devices found in the prior art, including such devices as shown in Sexton, U.S. Pat. No. 5,398,778, and Bradley, et al., U.S. Pat. No. 6,315,181. The vast majority of these devices, however, have one thing in common and that is that they secure ladders by engaging the rungs of the ladder which provides an inherently unstable mounting location on a ladder. For example, as the majority of ladder rungs on extendable ladders are at least semi-cylindrical in shape, it is far easier for the ladder securement element of those devices found in the prior art to slide off of the ladder rung, thus releasing the ladder to cause damage as it falls from the ladder rack. Another problem with those devices found in the prior art is that they often require multiple steps to secure the ladder on the ladder rack, such as fastening separate fastening elements to the ladder instead of being able to secure the ladder on the ladder rack in one convenient step. There is therefore a need for an improved ladder securement device for a ladder rack which will address and correct each of the problems not solved by the prior art and do so in a safe and efficient manner.

Therefore, an object of the present invention is to provide an improved ladder securement device for a ladder rack.

Another object of the present invention is to provide an improved ladder securement device for a ladder rack which includes a single pivot bar on which two or more ladder-engaging hooks are mounted, the ladder-engaging hooks operative to rotate with the pivot bar to engage a side rail of a ladder mounted on the ladder rack when the ladder-engaging hooks are in the ladder engaging position.

Another object of the present invention is to provide an improved ladder securement device for a ladder rack which may be used with virtually any type of ladder so long as the ladder includes at least one side rail for the ladder-engaging hooks to engage.

Another object of the present invention is to provide an improved ladder securement device for a ladder rack which includes a handle operatively connected to the pivot bar to rotate the pivot bar between the ladder engaging position and ladder release position such that the device may be operated by a person standing on the ground adjacent the ladder rack instead of requiring the person to climb the ladder rack to secure the ladder to the top of ladder rack.

Finally, an object of the present invention is to provide an improved ladder securement device for a ladder rack which is relatively simple and durable in construction and is safe, efficient, and effective in use.

### SUMMARY OF THE INVENTION

The present invention provides an improved ladder securement device for a ladder rack including at least one pivot mount adapted for mounting on a ladder rack and a generally horizontal pivot bar pivotably mounted on the at least one pivot mount rotatable about an axis generally defined by a center longitudinal axis of the pivot bar. At least two generally inverted L-shaped ladder-engaging hooks are mounted on the pivot bar adjacent opposite ends thereof, the ladder-engaging hooks pivotable between a ladder engaging position and a ladder release position and a handle is connected to the pivot bar for rotating the pivot bar about the center longitudinal axis thereof. Finally, the ladder-engaging hooks are adapted to extend over and engage a side rail of at least one ladder mounted on the ladder rack when the ladder-engaging hooks are in the ladder engaging position.

The present invention as thus described provides a substantial improvement over those devices found in the prior art operative for securing ladders on ladder racks. For example, because the ladder-engaging hooks of the present invention engage the side rails of the ladder to enclose the side rail generally on four sides thereof in combination with the ladder rack, the chances of the ladder slipping from the ladder rack and falling to the ground accidentally are virtually eliminated, barring catastrophic failure of the ladder rack structure and/or ladder securement device of the present invention. Also, because the ladder is secured on the ladder rack merely by rotating the hooks into the ladder securement position via the handle which is located below the ladder supporting frame of the ladder rack, it is unnecessary for the user of the present invention to climb up onto the ladder rack to secure the ladder thereon, thus greatly reducing the possibility of injury of the person securing the ladder on the ladder rack. Finally, because the ladder securement device of the present invention includes at least two spaced apart ladder-engaging hooks which are simultaneously pivoted to engage or disengage from the ladder, it is a far simpler procedure to secure a ladder on the ladder rack equipped with the present invention than in using those devices found in the prior art. It is thus seen that the ladder securement device of the present invention provides a substantial improvement over those devices found in the prior art.

### BRIEF DESCRIPTION OF THE DRAWINGS

FIG. 1 is a perspective view of the improved ladder securement device for a ladder rack of the present invention mounted on a vehicle;

FIG. 2 is a detailed perspective view of the present invention; and

FIG. 3 is a detailed end elevational view of the improved ladder securement device for a ladder rack of the present invention securing a ladder on a ladder rack.

### DESCRIPTION OF THE PREFERRED EMBODIMENT

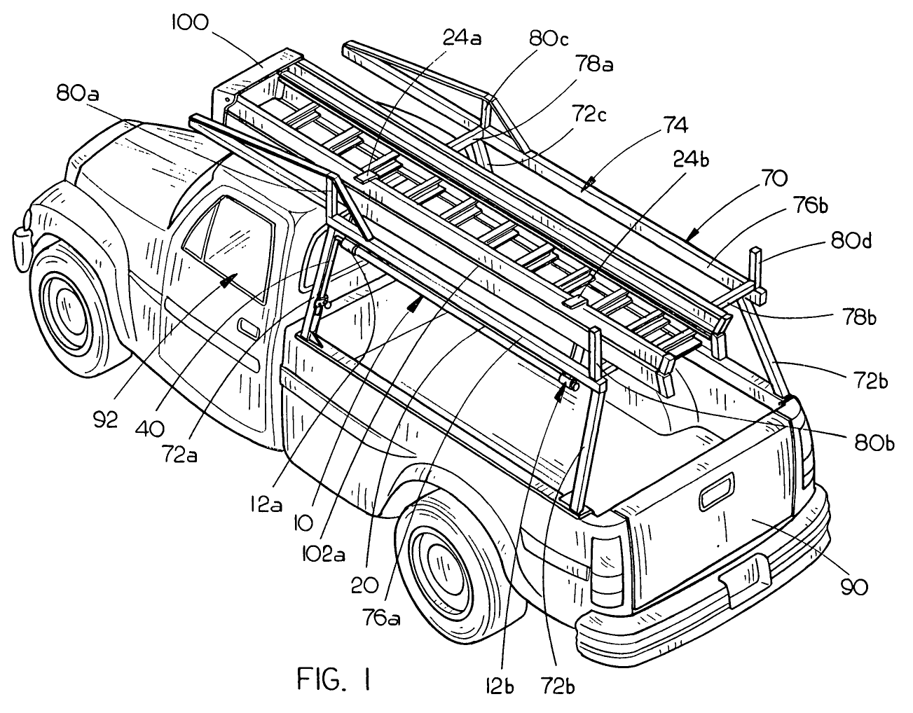

The improved ladder securement device 10 of the present invention is shown best in FIGS. 1-3 as being mounted on a ladder rack 70 which is mounted on a vehicle 90, the ladder rack 70 including a plurality of upwardly-extending support struts 72a, 72b, 72c and 72d which support the ladder support frame 74 above the cab 92 and bed of the vehicle 90. The ladder support frame 74 would preferably be generally rectangular in shape and would include a pair of longitudinally extending main frame beams 76a and 76b and at least two transversely extending ladder support beams 78a and 78b which extend between and connect the main frame beams 76a and 76b, as shown best in FIG. 1. Finally, extending upwards from the main frame beams 76a and 76b are a plurality of ladder retention struts 80a-d which generally prevent the ladder 100 being supported on the ladder rack 70 from sliding off the side of the ladder rack 70. Of course, there are numerous different types of ladder racks 70 which are adapted for mounting on vehicles 90, but the above description of a standard ladder rack should be understood to apply generally to those other ladder racks found in current use, and some variation from the above description is expected and will not affect the functionality of the improved ladder securement device 10 of the present invention when used in connection with many different types of ladder racks 70.

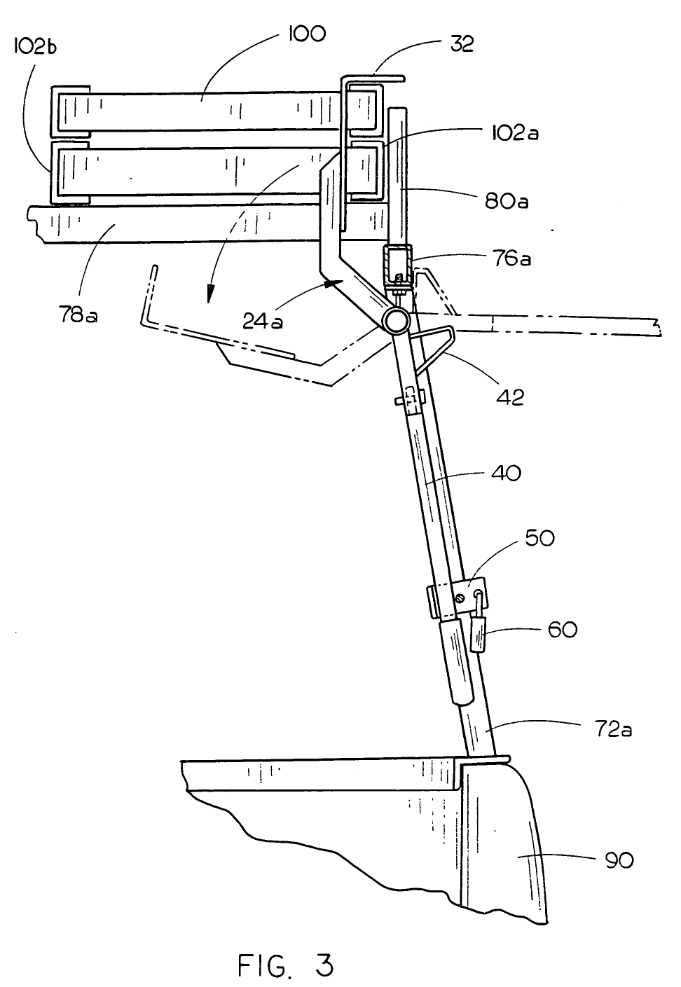

The improved ladder securement device 10 of the present invention is shown best in FIGS. 1-3 as including forward and rearward pivot brackets 12a and 12b each of which include a generally flat horizontal mounting plate 14, a downwardly depending pivot support strut 16 and a pivot bar mounting cylinder bearing 18 adapted to rotatably support the pivot bar 20 therein. As shown best in FIGS. 1 and 3, the pivot mount brackets 12a and 12b would each be mounted to the underside of one of the main frame beams 76a with the pivot mount brackets 12a and 12b being spaced from one another approximately four to seven feet, depending on the size of the ladder rack 70 and the length of pivot bar 20. It is expected that the pivot mount brackets 12a and 12b would be secured to the ladder rack 70 by bolt and nut combinations, screws or the like, although the exact means by which the pivot mount brackets 12a and 12b are secured to the main frame beam 76a is not critical to the present invention.

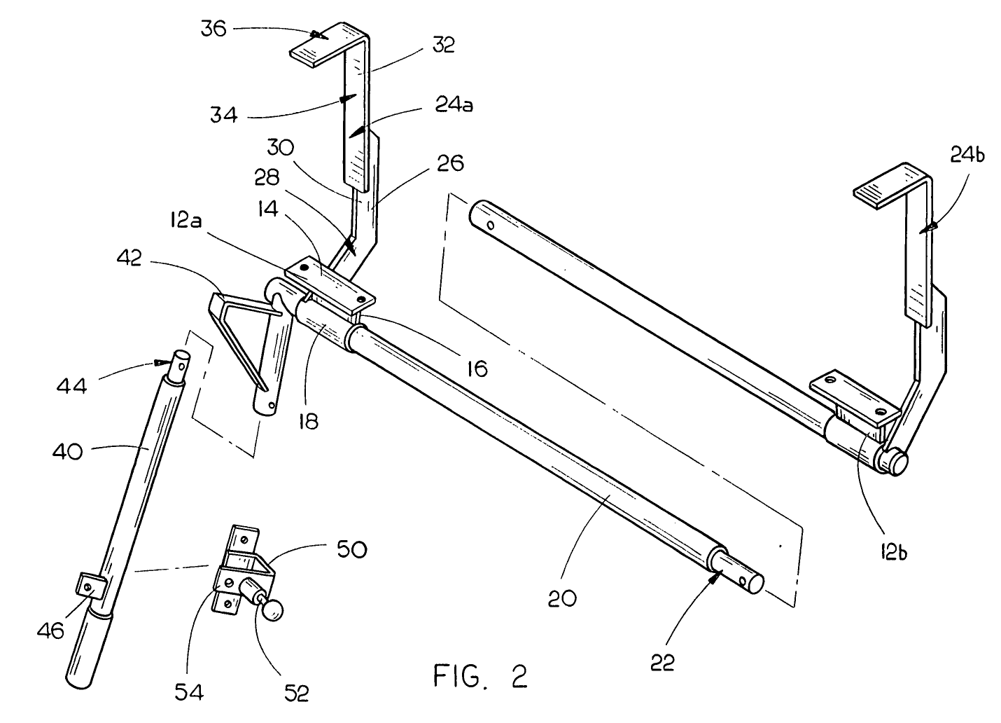

As shown best in FIGS. 2 and 3, the pivot bar 20 is preferably a longitudinally extended generally cylindrical metal bar which may be either solid or may be constructed as a hollow pipe, depending on the construction materials used and weight considerations taken into account in connection with the use of the present invention. It is further preferred that the pivot bar 20 have a length of approximately four to eight feet and have an outer diameter of approximately one inch, with the pivot bar 20 being rotatably mounted within the pivot bar mounting cylinder bearings 18 of pivot mount brackets 12a and 12b. Due to the length of pivot bar 20, it may be preferable to include a joint 22 which permits the pivot bar 20 to be separated into two sections, which also provides for simpler installation and replacement of the pivot bar 20 should such become necessary during use of the improved ladder securement device 10 of the present invention. In the preferred embodiment, this joint 22 would be of any standard kind of bar joint, such as the retractable pin and pin-receiving hole type of joint shown best in FIG. 2 in which the smaller diameter section of one-half of the pivot bar 20 is slid into the other half of pivot bar 20 and secured therein as the pin pops out of and extends through the hole shown in the second half of pivot bar 20. Of course, many different types of joints 22 may be used in connection with the pivot bar 20 of the present invention, and such substitution would be understood by those skilled in the art of metal fabrication.

Mounted on and extending upwards and inwards from opposite ends of pivot bar 20 are a pair of ladder-engaging hooks 24a and 24b, as shown best in FIGS. 2 and 3. As each of the ladder-engaging hooks 24a and 24b are generally identical, the following description of ladder-engaging hook 24a should be understood to apply equally to ladder-engaging hook 24b. Mounted on and extending upwards and inwards from pivot bar 20 is lower hook strut 26 which, in the preferred embodiment, would be a generally flat metal bar having a first section 28 which connects to the pivot bar 20 at the base thereof and an upper section 30 which extends at approximately a forty-five degree angle from the lower section 28 of lower hook strut 26 such that, when lower section 28 of lower hook strut 26 extends upwards and inwards from pivot bar 20, upper section 30 of lower hook strut 26 is generally upright, as shown in FIG. 3. Mounted on and extending upwards from upper section 30 of lower hook strut 26 is a generally inverted L-shaped upper ladder-engaging bar 32 which includes a first leg which extends upwards from upper section 30 of lower hook strut 26 and a second leg 36 which extends generally perpendicular to first leg 34 outwards therefrom. In the preferred embodiment, the upper ladder-engaging bar 32 would be a generally flat metal bar having a height of approximately four to eight inches on first leg 34 and having a width along second leg 36 of approximately two to six inches, depending on the ladder 100 to be retained on the ladder rack 70 and other functional features which will be determined through experimentation with the present invention.

Mounted on the forward end of pivot bar 20 and extending downwards therefrom is a handle 40 which, in the preferred embodiment, would have a length of approximately two to three feet and is operative to rotate the pivot bar 20 within the pivot bar mounting cylinder bearings 18 of pivot mount brackets 12a and 12b, as shown best in FIG. 3. The handle 40 would preferably also include a pivot stop 42 mounted on the upper end of the handle 40 which prevents overrotation of the pivot bar 20, and it is further preferred that the handle 40 be detachable from the pivot bar 20 by including a handle joint 44 which would operate in a manner similar to the pivot bar joint 22 of pivot bar 20 to permit the handle 40 to be separated and removed from the remainder of the improved ladder securement device 10 of the present invention. Finally, a latch assembly 50 is preferably mounted on one of the upwardly extending struts 72a of ladder rack 70 to releasably secure the handle 40 in the position adjacent the upwardly extending strut 72a, as shown best in FIGS. 2 and 3. Although the latch assembly 50 may be of any appropriate type which secures the handle 40 to the upwardly extending strut 72a, it is preferred that the latch assembly 50 include a spring-biased pin 52 which releasably extends to secure the handle 40 within the latch assembly 50, the latch assembly further including an outwardly extending tab section 54 which aligns with the pin-receiving tab 46 mounted on the lower end of handle 40 when the handle 40 is housed within latch assembly 50 to permit a lock 60 to extend through the pin-receiving tab 46 and forwardly extending tab 54 to lock the handle 40 in the position adjacent the upwardly extending strut 72a, as shown in FIG. 3.

The improved ladder securement device 10 of the present invention functions to secure a ladder 100 on a ladder rack 70 in the following manner. Initially, the handle 40 would be operated to rotate the pivot bar 20 and thus ladder-engaging hooks 24a and 24b to the ladder release position shown as a dotted line positioning of FIG. 3. Overrotation of the pivot bar 20 is prevented from happening by the pivot stop 42 mounted on handle 40 and, further, because of the weight balance of ladder-engaging hooks 24a and 24b versus handle 40, the pivot bar 20 preferably will remain rotated in its ladder release position until the handle 40 is physically pivoted downwards by an operator of the present invention. The ladder 100 would then be placed on top of the ladder rack 70 with the ladder extending over the ladder support beams 78a and 78b generally adjacent main frame beam 76a and hence generally adjacent ladder retention struts 80a and 80b. Specifically, it is the side rails 102a and 102b of the ladder 100 which are generally adjacent the ladder retention struts 80a and 80b, as shown best in FIGS. 1 and 3, which is a critical feature for the proper operation of the present invention.

Once the ladder 100 is positioned on ladder rack 70, the handle 40 is pivoted downwards, thus pivoting the ladder-engaging hooks 24a and 24b mounted on pivot bar 20 upwards and outwards into their ladder-engaging position shown by the solid line position of FIG. 3. The upper ladder-engaging bar 32 of each of the ladder-engaging hooks 24a and 24b engages the side rails 102a and 102b of the ladder 100 and the second leg 36 of upper ladder-engaging bar 32 extends over the side rails 102a and 102b, as shown in FIG. 3. The side rails 102a and 102b of ladder 100 are thus surrounded on all four sides of the side rails 102a and 102b, specifically by the ladder support beam 78a, ladder retention strut 80a, and the first and second legs 34 and 36 of upper ladder-engaging bar 32 of ladder-engaging hook 24a. It is thus virtually impossible for the ladder 100 to disengage and fall from the ladder rack 70, and therefore transportation of the ladder 100 on ladder rack 70 is made far safer and easier than transport of ladders by those devices found in the prior art.

Once the handle 40 has been pivoted downwards, it may be slid into latch assembly 50 by opening and then closing spring-biased pin 52, thus releasably retaining the handle 40 within the latch assembly 50. This, in turn, secures the ladder-engaging hooks 24a and 24b in their ladder-engaging position, as shown in FIGS. 1 and 3, thus securing the ladder 100 on the ladder rack 70. By adding the lock 60, accidental release of the handle 40 from latch assembly 50 is prevented, and the vehicle 90 may be safely driven without worrying if the ladder 100 will accidentally disengage from the ladder rack 70. Once the vehicle 90 has reached the location at which the ladder 100 is to be removed from the ladder rack 70, the lock 60 would be disengaged and the handle 40 would be swung outwards from latch assembly 50 to pivot the pivot bar 20 within pivot bar mounting cylinder bearings 18 of pivot mount brackets 12a and 12b to shift the ladder-engaging hooks 24a and 24b from their ladder-engaging position to the ladder release position. The ladder 100 may then be quickly and easily removed from the ladder rack 70 for use at the job site.

One of the benefits of the improved ladder securement device 10 of the present invention is that it is quite easy to install a pair of the ladder-securement devices 10 on opposite sides of a single ladder rack 70 to secure ladders on each side of the ladder rack 70, should such installation and use be desirable. Furthermore, one of the benefits of the present invention is that the ladder 100 need not be positioned precisely in a specific location on ladder rack 70 to permit the present invention to function correctly, as the ladder-engaging hooks 24a and 24b, when being moved from the ladder-release position to the ladder-engaging position, will engage the ladder 100, specifically side rails 102a and 102b of ladder 100, and shift the ladder to a position generally adjacent the ladder retention struts 80a and 80b, thus shifting the ladder 100 into the proper securement position on ladder rack 70 merely through operation of the improved ladder securement device 10 of the present invention. Also, because the improved ladder securement device 10 of the present invention engages the side rails 102a and 102b of ladder 100 to secure the ladder 100 on the ladder rack 70, it is relatively unimportant as to which type of ladder is to be secured on the ladder rack 70 as each and every ladder will include side rails, but may not include the particular type of ladder rung necessary for connection and securement as dictated by many of the inventions found in the prior art. Finally, because the pivot bar 20 and handle 40 may be separated and removed from the improved ladder securement device 10 of the present invention, the entire unit may be quickly and easily removed from the ladder rack 70 leaving only the pivot mount brackets 12a and 12b mounted thereon should a user of the present invention wish to remove the device from the ladder rack 70, a feature not generally found in those devices found in the prior art.

It is to be understood that numerous additions, modifications, and substitutions may be made to the improved ladder securement device 10 of the present invention which fall within the intended broad scope of the appended claims. For example, the size, shape, and construction materials used in connection with the improved ladder securement device 10 are not critical to the present invention so long as the functional characteristics of the device are neither degraded nor destroyed. Furthermore, the specific size and shape of the ladder-engaging hooks 24a and 24b may be modified or changed to accommodate various types of ladders 100 which will be used in connection with the present invention, and such modifications of size and shape are understood to be a part of this disclosure. Finally, it should be clear that through minor modification of the pivot mount brackets 12a and 12b and other elements of the improved ladder securement device 10 of the present invention, the present invention may be used in connection with virtually any type of ladder rack 70 currently being used on vehicles, and such modifications would be understood by one skilled in the art of metal fabrication and equipment modification.

There has therefore been shown and described an improved ladder securement device 10 which accomplishes at least all of its intended objectives.

I claim:

1. An improved ladder securement device for a ladder rack comprising:
at least one pivot mount adapted for mounting on a ladder rack;
a pivot bar pivotably mounted on said at least one pivot mount rotatable about an axis generally defined by a center longitudinal axis of said pivot bar;
at least two generally inverted L-shaped ladder-engaging hooks mounted on said pivot bar generally adjacent opposite ends thereof, said ladder-engaging hooks pivotable between a ladder engaging position and a ladder release position;
handle means connected to said pivot bar for rotating said pivot bar about the center longitudinal axis thereof; and
said ladder-engaging hooks adapted to extend over and engage a side rail of at least one ladder mounted on the ladder rack when said ladder-engaging hooks are in said ladder engaging position.

2. The improved ladder securement device for a ladder rack of claim 1 wherein said at least one pivot mount comprises two pivot mount brackets each including a pivot bar mounting cylinder bearing adapted to rotatably support said pivot bar therein.

3. The improved ladder securement device for a ladder rack of claim 1 wherein said pivot bar comprises a longitudinally extended generally cylindrical metal bar.

4. The improved ladder securement device for a ladder rack of claim 1 wherein said at least two generally inverted L-shaped ladder-engaging hooks each further comprise a lower hook strut mounted on and extending upwards and inwards from said pivot bar, said lower hook strut including a first section connected to said pivot bar adjacent the base thereof and an upper section which extends at an acute angle from said lower section of said lower hook strut.

5. The improved ladder securement device for a ladder rack of claim 4 wherein said at least two generally inverted L-shaped ladder-engaging hooks each further comprise a generally inverted L-shaped upper ladder-engaging bar mounted on and extending upwards from said upper section of said lower hook strut, said ladder-engaging bar including a first leg extending upwards from said upper section of said lower hook strut and a second leg extending generally perpendicular to said first leg outwards therefrom.

6. In combination:
a ladder rack mounted on a vehicle, said ladder rack including a plurality of upwardly-extending support struts and a ladder support frame mounted atop said plurality of support struts, said ladder support frame including at least two longitudinally extending main frame beams, at least two transversely extending ladder support beams extending between and connecting said main frame beams and a plurality of ladder retention struts which are mounted on and extend upwards from said main frame beams; and
an improved ladder securement device for said ladder rack including:
at least one pivot mount mounted on one of said main frame beams of said ladder rack;
a generally horizontal pivot bar pivotably mounted on said at least one pivot mount rotatable about an axis generally defined by a center longitudinal axis of said pivot bar and extending generally parallel with said one of said main frame beams;
at least two generally inverted L-shaped ladder-engaging hooks mounted on said pivot bar adjacent opposite ends thereof, said ladder-engaging hooks pivotable between a ladder engaging position extending over said one of said main frame beams and a ladder release position inwards of said one of said main frame beams;
handle means connected to said pivot bar for rotating said pivot bar about the center longitudinal axis thereof; and
said ladder-engaging hooks adapted to extend over and engage a side rail of at least one ladder mounted on said ladder rack adjacent said one of said main frame beams when said ladder-engaging hooks are in said ladder engaging position such that the side rail is surrounded on four sides thereof by said ladder-engaging hooks, at least one of said at least two transversely extending ladder support beams and at least one of said plurality of ladder retention struts thereby preventing unintentional dislodging of the ladder from said ladder rack.

7. The improved ladder securement device for a ladder rack of claim 6 wherein said at least one pivot mount comprises two pivot mount brackets each including a pivot bar mounting cylinder bearing adapted to rotatably support said pivot bar therein, said two pivot mount brackets each mounted to the underside of one of said at least two main frame beams, said two pivot mount brackets being spaced from one another along the length of said one of said at least two main frame beams.

8. The improved ladder securement device for a ladder rack of claim 6 wherein said pivot bar comprises a longitudinally extended generally cylindrical metal bar.

9. The improved ladder securement device for a ladder rack of claim 6 wherein said at least two generally inverted L-shaped ladder-engaging hooks each further comprise a lower hook strut mounted on and extending upwards and inwards from said pivot bar, said lower hook strut including a first section connected to said pivot bar adjacent the base thereof and an upper section which extends at an acute angle from said lower section of said lower hook strut.

10. The improved ladder securement device for a ladder rack of claim 9 wherein said at least two generally inverted L-shaped ladder-engaging hooks each further comprise a generally inverted L-shaped upper ladder-engaging bar mounted on and extending upwards from said upper section of said lower hook strut, said ladder-engaging bar including a first leg extending upwards from said upper section of said lower hook strut and a second leg extending generally perpendicular to said first leg outwards therefrom.

11. An improved ladder securement device for a ladder rack comprising:
two pivot mounts adapted for mounting on the same side of a ladder rack;
a generally horizontal pivot bar pivotably mounted on said two pivot mounts rotatable about an axis generally defined by a center longitudinal axis of said pivot bar;
at least two generally inverted L-shaped ladder-engaging hooks mounted on said pivot bar adjacent opposite ends thereof, said ladder-engaging hooks extending inwards and upwards from said pivot bar and being pivotable between a ladder engaging position generally above said pivot bar and a ladder release position generally inwards of said pivot bar;
handle means connected to said pivot bar for rotating said pivot bar about the center longitudinal axis thereof; and
said ladder-engaging hooks adapted to extend over and engage a side rail of at least one ladder mounted on the ladder rack when said ladder-engaging hooks are in said ladder engaging position.
